(19) United States
(12) Patent Application Publication
(10) Pub. No.: US 2026/0371407 A1
(43) Pub. Date: Nov. 19, 2026

(54) METHOD FOR SHARING COT, COMMUNICATION DEVICE AND STORAGE MEDIUM

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd., Beijing (CN)

(21) Appl. No.: 19/143,120

(22) PCT Filed: Dec. 29, 2022
(86) PCT No.: PCT/CN2022/143670

§ 371 Date: Jun. 25, 2025

(51) Int. Cl. H04W 74/08; H04W 28/02; H04W 76/40

(52) U.S. Cl. CPC H04W 74/0866; H04W 28/0278; H04W 76/40

(57) ABSTRACT

A method for sharing a channel occupancy time (COT), including: receiving information related to a channel access priority class (CAPC) sent by a second terminal device.

### CROSS-REFERENCE TO RELATED APPLICATION

The present application is a U.S. National Stage of International Application No. PCT/CN2022/143670, filed on Dec. 29, 2022, the contents of all of which are incorporated herein by reference in their entirety for all purposes.

### BACKGROUND OF THE INVENTION

In the related art, uplink and downlink operations may be performed in an unauthorized frequency band. Channel access, for both a downlink and an uplink, relies on a listen before talk (LBT) feature. A terminal device, which performs LBT detection, may share a preempted channel occupancy time (COT) with other terminal devices for use. The terminal device, which initiates sharing of the COT, may be referred to as a COT initiating terminal.

### SUMMARY OF THE INVENTION

The present disclosure relates to the technical field of communications, in particular to a method and a device for sharing a COT.

An embodiment of a first aspect of the present disclosure provides a method for sharing a COT, including: receiving information related to a channel access priority class (CAPC) sent by a second terminal device.

An embodiment of a second aspect of the present disclosure provides another method for sharing a COT, including: sending information related to a channel access priority class (CAPC) to a first terminal device.

An embodiment of a third aspect of the present disclosure provides a communication device, including one or more processors and a memory. A computer program is stored in the memory. The one or more processors are collectively configured to execute the computer program stored in the memory to cause the communication device to receive information related to a channel access priority class (CAPC) sent by a second terminal device.

An embodiment of a fourth aspect of the present disclosure provides another communication device, including one or more processors and a memory. A computer program is stored in the memory. The one or more processors are collectively configured to execute the computer program stored in the memory to cause the communication device to perform the method according to the above second aspect.

An embodiment of a fifth aspect of the present disclosure provides a non-transitory computer-readable storage medium, configured to store instructions used by the above communication device. When executed, the instructions cause the communication device to perform the method according to the above first aspect.

An embodiment of a sixth aspect of the present disclosure provides another non-transitory computer-readable storage medium, configured to store instructions used by the above communication device. When executed, the instructions cause the communication device to perform the method according to the above second aspect.

### BRIEF DESCRIPTION OF DRAWINGS

In order to more clearly illustrate technical solutions in embodiments of the present disclosure or the background, the accompanying drawings that need to be used in the embodiments of the present disclosure or the background are described below.

FIG. 1 is a schematic architectural diagram of a communication system provided by an embodiment of the present disclosure.

FIG. 2 is a schematic flowchart of a method for sharing a COT provided by an embodiment of the present disclosure.

FIG. 3 is a schematic flowchart of a method for sharing a COT provided by another embodiment of the present disclosure.

FIG. 4 is a schematic flowchart of a method for sharing a COT provided by another embodiment of the present disclosure.

FIG. 5 is a schematic flowchart of a method for sharing a COT provided by another embodiment of the present disclosure.

FIG. 6 is a schematic flowchart of a method for sharing a COT provided by another embodiment of the present disclosure.

FIG. 7 is a schematic flowchart of a method for sharing a COT provided by another embodiment of the present disclosure.

FIG. 8 is a schematic flowchart of a method for sharing a COT provided by another embodiment of the present disclosure.

FIG. 9 is a schematic flowchart of a method for sharing a COT provided by another embodiment of the present disclosure.

FIG. 10 is a schematic flowchart of a method for sharing a COT provided by another embodiment of the present disclosure.

FIG. 11 is a schematic structural diagram of a communication device provided by an embodiment of the present disclosure.

FIG. 12 is a schematic structural diagram of a communication device provided by another embodiment of the present disclosure.

FIG. 13 is a schematic structural diagram of a chip provided by an embodiment of the present disclosure.

### DETAILED DESCRIPTION OF THE INVENTION

In order to better understand a method for sharing a COT disclosed by an embodiment of the present disclosure, a communication system to which the embodiment of the present disclosure is applicable is first described below.

Please refer to FIG. 1. FIG. 1 is a schematic architecture diagram of a communication system provided by an embodiment of the present disclosure. The communication system may include, but is not limited to, one network device and two terminal devices. The terminal devices are connected with each other via a sidelink (SL). The number and forms of devices shown in FIG. 1 are merely for example and do not constitute a limitation of the embodiment of the present disclosure. Two or more network devices and two or more terminal devices may be included in actual applications. The communication system shown in FIG. 1 is an example including one network device 11 and two terminal devices 12 and 13. The terminal device 12 and the terminal device 13 are connected to each other via an SL. The communication system may further include a core network device 10 to communicate with the network device 11.

In the present disclosure, the terminal device 12 may be a sending end, and the terminal device 13 may be an opposite end, where there may be one or more terminal devices 13, which is not limited in the present disclosure. Or, the terminal device 13 may be a sending end, and the terminal device 12 may be an opposite end, where there may be one or more terminal devices 12, which is not limited in the present disclosure.

The technical solution of the embodiment of the present disclosure may be applied to various communication systems, for example, a long term evolution (LTE) system, a 5th generation (5G) mobile communication system, a 5G new radio (NR) system, or other novel mobile communication systems in the future. It further needs to be noted that the sidelink in the embodiment of the present disclosure may further be referred to as a side link or a direct communication link.

The network device 11 in the embodiment of the present disclosure is an entity on a network side and configured to transmit or receive a signal. For example, the network device 11 may be an evolved NodeB (eNB), a transmission reception point (TRP), a next generation NodeB (gNB) in an NR system, a base station in other future mobile communication systems, or an access node in a wireless fidelity (WiFi) system, etc. A specific technology and specific device form adopted for the network device is not limited in the embodiment of the present disclosure. The network device provided by the embodiment of the present disclosure may include a central unit (CU) and a distributed unit (DU), where the CU may also be referred to as a control unit. Adopting a CU-DU structure may divide a protocol layer of the network device, e.g., the base station. A function of part of the protocol layer is placed in the CU for a central control. A function of the rest part or all of the protocol layer is distributed in the DU. The DU is centrally controlled by the CU.

The terminal device in the embodiment of the present disclosure is an entity on a user side and configured to receive or transmit a signal, such as a mobile phone. The terminal device may be referred to as a terminal, user equipment (UE), a mobile station (MS), a mobile terminal (MT), etc. The terminal device may be a car with a communication function, a smart car, a mobile phone, a wearable device, a pad, a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, etc. A specific technology and specific device form adopted for the terminal device is not limited in the embodiment of the present disclosure.

It may be understood that the communication system described in the embodiment of the present disclosure is to more clearly illustrate the technical solution of the embodiment of the present disclosure, and does not constitute a limitation of the technical solution provided by the embodiment of the present disclosure. It may be known to those ordinarily skilled in the art that with the evolution of a system architecture and the emergence of new service scenarios, the technical solution provided by the embodiment of the present disclosure is also suitable for similar technical problems.

Usually, a terminal device that performs LBT detection may share a preempted COT with other terminal devices for use. COT wasting is caused if the COT initiating terminal shares the COT with a terminal device, which cannot use the COT.

In the present disclosure, a first terminal device may receive information related to a channel access priority class (CAPC) sent by a second terminal device. Thus, when initiating COT sharing, the first terminal device can determine, based on the information related to the CAPC, whether to share the COT with the second terminal device, so that COT wasting caused by sharing the COT with the terminal device that cannot use the COT can be avoided.

A method and device for sharing a COT provided by the present disclosure are introduced in detail below in conjunction with the accompanying drawings.

Firstly, it is stated that down sidelink communication may have the following two allocation manners of transmission resources. One manner is network scheduling of the transmission resources (which may be called mode1). The other manner is autonomous selection of the transmission resources (which may be called mode2). The network scheduling of the transmission resources may mean that a network device dynamically allocates the transmission resources on a sidelink to a terminal device according to a cache data report of the terminal device, or that the network device semi-statically configures the transmission resources on the sidelink to the terminal device. The autonomous selection of the transmission resource may mean that the terminal device itself randomly selects transmission resources in a webcast or pre-configured resource pool.

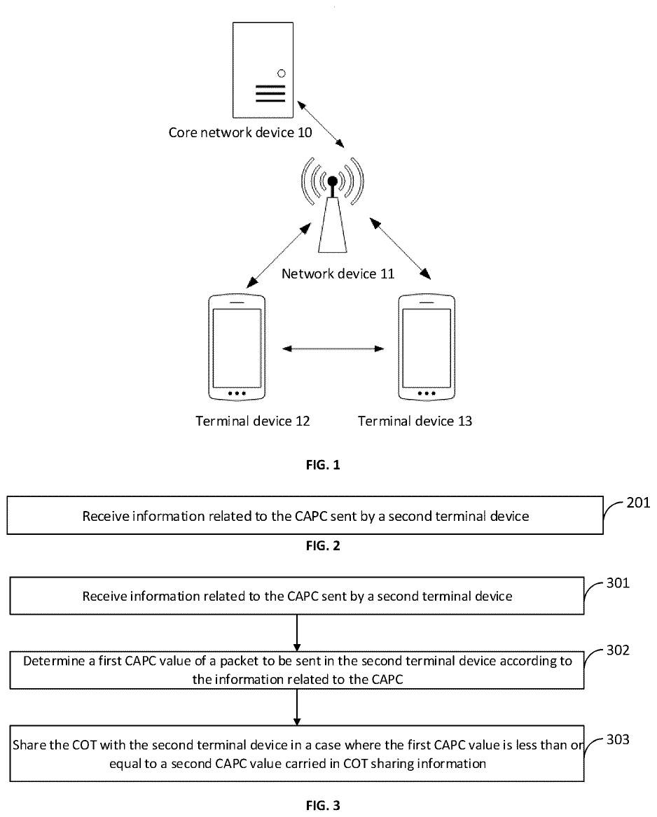

FIG. 2 is a schematic flowchart of a method for sharing a COT provided by an embodiment of the present disclosure. The method is performed by a first terminal device. As shown in FIG. 2, the method may include, but is not limited to, the following steps.

Step 201, information related to the CAPC sent by a second terminal device is received.

In the present disclosure, a CAPC may be used to indicate a priority class for accessing channel for a packet to be sent. The CAPC is a parameter related to LBT. Different CAPC values affect priority classes in competing the channel. The smaller the CAPC value, the higher the priority class.

Other names may also be used to refer to the priority class of the access channel, which is not limited in the present disclosure.

In the present disclosure, the first terminal device may receive the information related to the CAPC sent by the second terminal device. The information related to the CAPC may be understood as information related to the CAPC. The information related to the CAPC may be, for example, one or more of a sidelink buffer status report (SL-BSR), CAPC information, etc., or other information, which is not limited in the present disclosure.

The SL-BSR may be used to determine a first CAPC value of one or more packets to be sent. The first CAPC value of the one or more packets to be sent may be carried in the CAPC information.

Optionally, when a plurality of first CAPC values are carried in the CAPC information, a plurality of target addresses may further be carried. Each target address corresponds to one first CAPC value. Each target address has one packet to be sent. The first CAPC value corresponding to each target address is the first CAPC value of this packet to be sent.

In the present disclosure, the first terminal device may be a terminal device that establishes a unicast connection with the second terminal device, or may be a terminal device that belongs to a same multicast service as the second terminal device, or may be a terminal device that receives a same broadcast service as the second terminal device, or may be a terminal device that establishes the unicast connection with the second terminal device and receives the packet to be sent, or may be a terminal device that establishes the unicast connection with the second terminal device, where the second terminal device has the SL data to be sent to the terminal device.

The present embodiment may be combined with optional examples in other embodiments in the absence of contradiction, which is not limited in the present disclosure.

In the embodiment of the present disclosure, the first terminal device may receive the information related to the CAPC sent by the second terminal device. Thus, when initiating COT sharing, the first terminal device can determine, based on the information related to the CAPC, whether to share the COT with the second terminal device, so that COT wasting caused by sharing the COT with a terminal device that cannot use the COT can be avoided. FIG. 3 is a schematic flowchart of a method for sharing a COT provided by another embodiment of the present disclosure. The method is performed by a first terminal device, and the first terminal device is a COT initiating terminal. As shown in FIG. 3, the method may include, but is not limited to, the following steps.

Step 301, information related to the CAPC sent by a second terminal device is received.

In the present disclosure, step 301 may be implemented by adopting any manner of the various embodiments of the present disclosure, respectively, which is not limited in the embodiment of the present disclosure and will not be repeated.

Step 302, a first CAPC value is determined according to the information related to the CAPC.

In the present disclosure, the information related to the CAPC may be an SL-BSR or may be CAPC information.

The SL-BSR may be a periodic SL-BSR or a regular SL-BSR, which is not limited in the present disclosure.

In the present disclosure, the SL-BSR may carry at least one of a target address, a logical channel group of each target address, an amount of data buffered in each logical channel group, etc., or may carry other information, which is not limited in the present disclosure.

In the present disclosure, if the information related to the CAPC is the SL-BSR, the first terminal device may determine how much buffered data there is for the logical channel in each priority class according to the SL-BSR. The packet is obtained by combining according to priority classes of logical channels, and thus it may be determined, according to the SL-BSR, that data of which logical channels may be put into a next packet, i.e., the packet to be sent. A first CAPC value of the packet to be sent may be determined according to CAPC values of these logical channels.

In the present disclosure, the CAPC information may include a first CAPC value of one or more packets to be sent.

Optionally, when a plurality of first CAPC values are carried in the CAPC information, a plurality of target addresses may further be carried. Each target address corresponds to one first CAPC value. Each target address has one packet to be sent. The first CAPC value corresponding to each target address is the first CAPC value of this packet to be sent.

In the present disclosure, if the information related to the CAPC is the CAPC information, the first terminal device may determine the first CAPC value of the packet to be sent in the second terminal device according to the CAPC information sent by the second terminal device.

Optionally, if a plurality of target addresses and a first CAPC value corresponding to each target address are carried in the CAPC information, then the first terminal device may determine a target address of each packet to be sent and a first CAPC value of each packet to be sent according to the CAPC information.

Optionally, there may be a plurality of packets to be sent. The target address of each packet to be sent may be different. The target address of each packet to be sent and the first CAPC value of each packet to be sent may be determined according to the SL-BSR.

In the present disclosure, the packet to be sent in the second terminal device may only be sent to the first terminal device.

Optionally, the packet to be sent may be sent to the first terminal device or sent to other terminal devices.

Step 303, the COT is shared with the second terminal device in a case where the first CAPC value is less than or equal to a second CAPC value carried in COT sharing information.

In the present disclosure, the first terminal device may compare the first CAPC value of the packet to be sent in the second terminal device with the second CAPC value carried in the COT sharing information. If the first CAPC value is less than or equal to the second CAPC value, the COT may be shared with the second terminal device.

Optionally, the second terminal device may be a target receiving terminal of the first terminal device.

The present embodiment may be combined with optional examples in other embodiments in the absence of contradiction, which is not limited in the present disclosure.

In the embodiment of the present disclosure, if the first terminal device is a COT initiating terminal, the COT initiating terminal may receive the information related to the CAPC sent by the second terminal device, and determine the first CAPC value according to the information related to the CAPC. The COT is shared with the second terminal device in a case where the first CAPC value is less than or equal to the second CAPC value carried in the COT sharing information. Thus, the COT initiating terminal may determine the CAPC value of the packet to be sent in the second terminal device according to the received information related to the CAPC sent by the second terminal device, so that the COT may be shared with the second terminal device that has the packet to be sent with the CAPC value less than or equal to the CAPC value carried in the COT sharing information. Then, COT wasting caused by sharing the COT with a terminal device, which cannot use the COT, can be avoided.

FIG. 4 is a schematic flowchart of a method for sharing a COT provided by another embodiment of the present disclosure. The method is performed by a second terminal device. As shown in FIG. 4, the method may include, but is not limited to, the following steps.

Step 401, information related to the CAPC is sent to a first terminal device.

In the present disclosure, the information related to the CAPC may be, for example, one or more of a sidelink buffer status report (SL-BSR), CAPC information, etc., or other information, which is not limited in the present disclosure.

The SL-BSR may be used to determine a first CAPC value of one or more packets to be sent. The first CAPC value of the one or more packets to be sent may be carried in the CAPC information.

Optionally, when a plurality of first CAPC values are carried in the CAPC information, a plurality of target addresses may further be carried. Each target address corresponds to one first CAPC value. Each target address has one packet to be sent. The first CAPC value corresponding to each target address is the first CAPC value of this packet to be sent.

In the present disclosure, the first terminal device may be a terminal device that establishes a unicast connection with the second terminal device, or may be a terminal device that belongs to a same multicast service as the second terminal device, or may be a terminal device that receives a same broadcast service as the second terminal device, or may be a terminal device that establishes the unicast connection with the second terminal device and receives the packet to be sent, or may be a terminal device that establishes the unicast connection with the second terminal device, where the second terminal device has the SL data to be sent to the terminal device.

The present embodiment may be combined with optional examples in other embodiments in the absence of contradiction, which is not limited in the present disclosure.

In the embodiment of the present disclosure, the second terminal device may send the information related to the CAPC to the first terminal device. Thus, when initiating COT sharing, the first terminal device can determine, based on the information related to the CAPC, whether to share the COT with the second terminal device, so that COT wasting caused by sharing the COT with a terminal device, which cannot use the COT, can be avoided.

FIG. 5 is a schematic flowchart of a method for sharing a COT provided by another embodiment of the present disclosure. The method is performed by a second terminal device. As shown in FIG. 5, the method may include, but is not limited to, the following steps.

Step 501, the information related to the CAPC is sent to a first terminal device in a case where a trigger condition for the information related to the CAPC is met.

In the present disclosure, the explanatory description of the information related to the CAPC may refer to the other embodiments, so it will not be repeated here.

In the present disclosure, the CAPC trigger condition may include at least one of: a sidelink BSR periodic timer timing out; a sidelink BSR retransmission timer timing out and at least one logical channel belonging to a logical channel group (LCG) having sidelink (SL) data; a first logical channel of an LCG belonging to any target address having the SL data arriving at a media access control (MAC) entity, and a priority class of the first logical channel is higher than a priority class of any LCH with the SL data contained in the LCG belonging to the same target address; or an LCH among the LCG belonging to any target address having the SL data arriving at a media access control (MAC) entity, and all LCHs contained in the LCG belonging to the same target address not having the SL data available for sending.

For example, a name of the sidelink BSR periodic timer may be sl-periodicBSR-Timer, or may be other names, which is not limited in the present disclosure.

For example, a name of the sidelink BSR retransmission timer may be sl-retxBSR-Timer, or may be other names, which is not limited in the present disclosure.

In the present disclosure, if the information related to the CAPC is an SL-BSR, that is, when meeting the SL-BSR trigger condition, the second terminal device sends the SL-BSR to the first terminal device. If the information related to the CAPC is CAPC information, that is, when meeting the CAPC trigger condition, the second terminal device sends the CAPC information to the first terminal device.

In the present disclosure, the first terminal device may be a terminal device that establishes a unicast connection with the second terminal device, or may be a terminal device that belongs to a same multicast service as the second terminal device, or may be a terminal device that receives a same broadcast service as the second terminal device, or may be a terminal device that establishes the unicast connection with the second terminal device and receives the packet to be sent, or may be a terminal device that establishes the unicast connection with the second terminal device, where the second terminal device has the SL data to be sent to the terminal device.

Optionally, an allocation manner of transmission resources of the second terminal device may be network scheduling of the transmission resources or autonomous selection of the transmission resources.

Optionally, the information related to the CAPC is canceled in a case where the second terminal device determines that the information related to the CAPC is sent to all first terminal devices.

The present embodiment may be combined with optional examples in other embodiments in the absence of contradiction, which is not limited in the present disclosure.

In the embodiment of the present disclosure, the second terminal device may send the information related to the CAPC to the first terminal device when meeting the trigger condition for the information related to the CAPC. Thus, the waste of resources can be avoided. Moreover, when initiating COT sharing, the first terminal device can determine, based on the information related to the CAPC, whether to share the COT with the second terminal device, so that COT wasting caused by sharing the COT with a terminal device, which cannot use the COT, can be avoided.

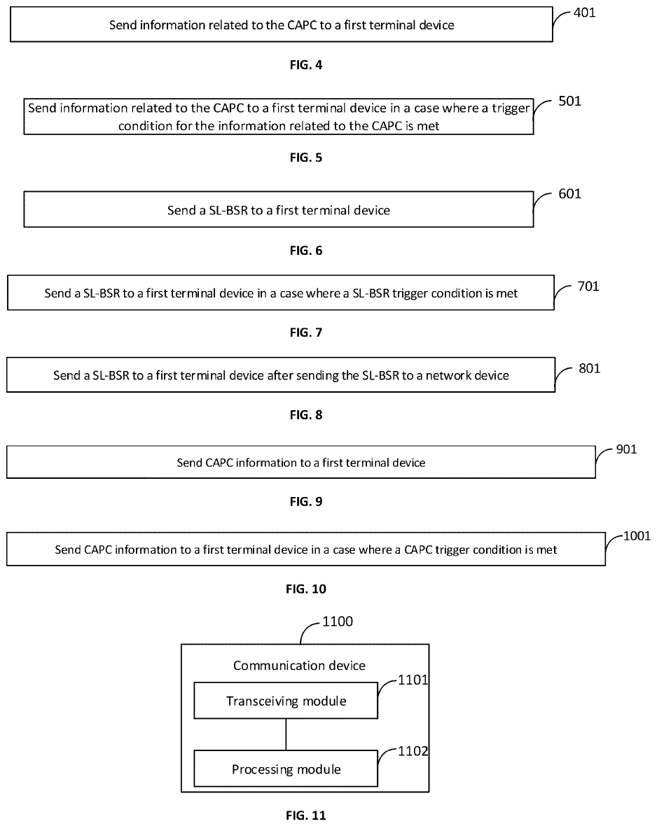

FIG. 6 is a schematic flowchart of a method for sharing a COT provided by another embodiment of the present disclosure. The method is performed by a second terminal device. As shown in FIG. 6, the method may include, but is not limited to, the following steps.

Step 601, an SL-BSR is sent to a first terminal device.

In the present disclosure, information related to the CAPC may be the SL-BSR. The second terminal device may send the SL-BSR to the first terminal device. The SL-BSR may be used to determine a first CAPC value of a packet to be sent in the second terminal device.

In the present disclosure, the second terminal device may have one or more packets to be sent, which is not limited in the present disclosure.

In the present disclosure, the first terminal device may be a terminal device that establishes a unicast connection with the second terminal device, or may be a terminal device that belongs to a same multicast service as the second terminal device, or may be a terminal device that receives a same broadcast service as the second terminal device, or may be a terminal device that establishes the unicast connection with the second terminal device and receives the packet to be sent, or may be a terminal device that establishes the unicast connection with the second terminal device, where the second terminal device has the SL data to be sent to the terminal device.

Optionally, the SL-BSR may be canceled in a case where the second terminal device determines that the SL-BSR is sent to all first terminal devices.

If the first terminal device is a COT initiating terminal, then the first terminal device may determine a first CAPC value of a packet to be sent in the second terminal device according to the SL-BSR, so as to determine whether to share the COT with the second terminal device according to the first CAPC value.

In the present disclosure, the packet to be sent in the second terminal device may only be sent to the first terminal device.

Optionally, the packet to be sent may be sent to the first terminal device or sent to other terminal devices.

Optionally, an allocation manner of transmission resources of the second terminal device may be autonomous selection of the transmission resources, i.e., mode2. That is, the terminal device run in mode2 may send the SL-BSR to an opposite end.

The present embodiment may be combined with optional examples in other embodiments in the absence of contradiction, which is not limited in the present disclosure.

In the embodiment of the present disclosure, the second terminal device may send the SL-BSR to the first terminal device. Thus, if the first terminal device is a COT initiating terminal, then the first terminal device may determine a first CAPC value of a packet to be sent in the second terminal device according to the SL-BSR, so as to determine whether to share the COT with the second terminal device according to the first CAPC value. COT wasting caused by sharing the COT with a terminal device, which cannot use the COT, can be avoided.

FIG. 7 is a schematic flowchart of a method for sharing a COT provided by another embodiment of the present disclosure. The method is performed by a second terminal device. As shown in FIG. 7, the method may include, but is not limited to, the following steps.

Step 701, a SL-BSR is sent to a first terminal device in a case where a SL-BSR trigger condition is met.

In the present disclosure, information related to the CAPC may be the SL-BSR. The second terminal device may send the SL-BSR to the first terminal device in a case of meeting the SL-BSR trigger condition.

Optionally, an allocation manner of transmission resources of the second terminal device may be autonomous selection of the transmission resources, i.e., mode2.

In the present disclosure, the SL-BSR may be a periodic SL-BSR or a regular SL-BSR, which is not limited in the present disclosure.

In the present disclosure, a sidelink BSR periodic timer times out, and the periodic SL-BSR is triggered. The second terminal device may send the periodic SL-BSR to the first terminal device. For example, a name of the sidelink BSR periodic timer may be sl-periodicBSR-Timer, or may be other names, which is not limited in the present disclosure.

Optionally, when a sidelink BSR retransmission timer times out and at least one logical channel belonging to a logical channel group has sidelink (SL) data, the regular SL-BSR is triggered, and the second terminal device may send the regular SL-BSR to the first terminal device. For example, a name of the sidelink BSR retransmission timer may be sl-retxBSR-Timer, or may be other names, which is not limited in the present disclosure.

Optionally, when a first logical channel of an LCG belonging to any target address has the SL data arriving at the MAC entity, and a priority class of the first logical channel is higher than a priority class of any LCH with the SL data contained in the LCG belonging to the same target address, the regular SL-BSR is triggered, and the second terminal device may send the regular SL-BSR to the first terminal device.

Optionally, an LCH among the LCG belonging to any target address has the SL data arriving at the MAC entity, and all LCHs contained in the LCG belonging to the same target address do not have the SL data available for sending, the regular SL-BSR is triggered, and the second terminal device may send the regular SL-BSR to the first terminal device.

In the present disclosure, the second terminal device may send the periodic SL-BSR or the regular SL-BSR to all terminal devices that establish unicast connections with the second terminal device. Optionally, the second terminal device may send the periodic SL-BSR or the regular SL-BSR to a terminal device that belongs to a same multicast service as the second terminal device. Optionally, the second terminal device may send the periodic SL-BSR or the regular SL-BSR to a terminal device that receives a same broadcast service as the second terminal device. Optionally, the second terminal device may send the periodic SL-BSR or the regular SL-BSR to a terminal device, which establishes a unicast connection with the second terminal device and is a receiving terminal device of a packet to be sent. Optionally, the second terminal device may send the periodic SL-BSR or the regular SL-BSR to a terminal device that establishes a unicast connection with the second terminal device and to which the second terminal device has the SL data to be sent. That is, a buffer size corresponding to at least one LCG contained in the target address associated with this terminal device in the SL-BSR is not 0. Optionally, the second terminal device may select certain opposite end devices to which the SL-BSR is sent.

Optionally, the SL-BSR may be canceled in a case where the second terminal device determines that the SL-BSR is sent to all first terminal devices.

The present embodiment may be combined with optional examples in other embodiments in the absence of contradiction, which is not limited in the present disclosure.

In the embodiment of the present disclosure, the second terminal device may send the SL-BSR to the first terminal device when meeting the SL-BSR trigger condition. Thus, the waste of resources may be avoided. Moreover, if the first terminal device is a COT initiating terminal, then the first terminal device may determine a first CAPC value of a packet to be sent in the second terminal device according to the SL-BSR, so as to determine whether to share the COT with the second terminal device according to the first CAPC value. COT wasting caused by sharing the COT with a terminal device, which cannot use the COT, can be avoided.

FIG. 8 is a schematic flowchart of a method for sharing a COT provided by another embodiment of the present disclosure. The method is performed by a second terminal device. As shown in FIG. 8, the method may include, but is not limited to, the following steps.

Step 801, an SL-BSR is sent to a first terminal device after sending the SL-BSR to a network device.

In the present disclosure, information related to the CAPC may be the SL-BSR. After the second terminal device sends the SL-BSR to the network device, the network device may schedule SL resources to the second terminal device according to the SL-BSR. Then the second terminal device may send the SL-BSR to the first terminal device utilizing the SL resources.

The explanatory description of the first terminal device may refer to the other embodiments, so it will not be repeated here.

In the present disclosure, an allocation manner of transmission resources of the second terminal device may be network scheduling of the transmission resources.

Optionally, the allocation manner of the transmission resources of the second terminal device may be network scheduling of the transmission resources, i.e., mode1.

The present embodiment may be combined with optional examples in other embodiments in the absence of contradiction, which is not limited in the present disclosure.

In the embodiment of the present disclosure, the second terminal device may send the SL-BSR to the first terminal device after sending the SL-BSR to the network device. Thus, the second terminal device may further send the SL-BSR to the first terminal device after sending the SL-BSR to the network device. If the first terminal device is a COT initiating terminal, then the first terminal device may determine a first CAPC value of a packet to be sent in the second terminal device according to the SL-BSR, so as to determine whether to share the COT with the second terminal device according to the first CAPC value. COT wasting caused by sharing the COT with a terminal device, which cannot use the COT, can be avoided.

FIG. 9 is a schematic flowchart of a method for sharing a COT provided by another embodiment of the present disclosure. The method is performed by a second terminal device. As shown in FIG. 9, the method may include, but is not limited to, the following steps.

Step 901, CAPC information is sent to a first terminal device.

In the present disclosure, information related to the CAPC may be the CAPC information. The second terminal device may determine CAPC information of a packet to be sent according to the SL-BSR and send the CAPC information to the first terminal device. The CAPC information may include a first CAPC value of one or more packets to be sent, then the CAPC information may be used to determine a first CAPC value of one packet to be sent in the second terminal device, or determine a first CAPC value of each packet to be sent in the plurality of packets to be sent.

Optionally, when a plurality of first CAPC values are carried in the CAPC information, the CAPC information may further carry a plurality of target addresses. Each target address corresponds to one first CAPC value. Each target address has one packet to be sent. The first CAPC value corresponding to each target address is the first CAPC value of this packet to be sent.

The explanatory description of the first terminal device may refer to the other embodiments, so it will not be repeated here.

Optionally, the CAPC information is canceled in a case where the second terminal device determines that the CAPC information is sent to all first terminal devices.

In the present disclosure, the packet to be sent in the second terminal device may only be sent to the first terminal device.

Optionally, the packet to be sent may be sent to the first terminal device or sent to other terminal devices.

Optionally, the second terminal device may carry the CAPC information via a sidelink media access control control element (SL MAC CE), PC5 radio resource control (PC5-RRC) signaling, or sidelink control information (SCI), etc.

Optionally, an allocation manner of transmission resources of the second terminal device may be autonomous selection of the transmission resources, i.e., mode2, or network scheduling of the transmission resources, i.e., mode1. That is, the terminal device run in mode1 or mode2 may send the CAPC information to an opposite end.

The present embodiment may be combined with optional examples in other embodiments in the absence of contradiction, which is not limited in the present disclosure.

In the embodiment of the present disclosure, the second terminal device may send the CAPC information sent to the first terminal device. Thus, the second terminal device may directly send the CAPC information of the packet to be sent to the first terminal device. If the first terminal device is a COT initiating terminal, the first CAPC value may be determined according to the CAPC information, COT wasting caused by sharing the COT with a terminal device, which cannot use the COT, can be avoided.

FIG. 10 is a schematic flowchart of a method for sharing a COT provided by another embodiment of the present disclosure. The method is performed by a second terminal device. As shown in FIG. 10, the method may include, but is not limited to, the following steps.

Step 1001, CAPC information is sent to a first terminal device in a case where a CAPC trigger condition is met.

In the present disclosure, information related to the CAPC may be the CAPC information. The second terminal device may send the CAPC information to the first terminal device in a case of meeting the CAPC trigger condition. The explanatory description of the first terminal device and the CAPC information may refer to the other embodiments, so it will not be repeated here.

In the present disclosure, the CAPC trigger condition may include at least one of: a sidelink BSR periodic timer timing out; a sidelink BSR retransmission timer timing out and at least one logical channel belonging to a logical channel group (LCG) having sidelink (SL) data; a first logical channel of an LCG belonging to any target address having the SL data arriving at a media access control (MAC) entity, and a priority class of the first logical channel is higher than a priority class of any LCH with the SL data contained in the LCG belonging to the same target address; or an LCH among the LCG belonging to any target address having the SL data arriving at the MAC entity, and all LCHs contained in the LCG belonging to the same target address not having the SL data available for sending.

That is, when meeting an SL-BSR trigger condition, the second terminal device may send the CAPC information to the first terminal device.

Optionally, when meeting the SL-BSR trigger condition, the second terminal device may send any one of the SL-BSR or the CAPC information to the first terminal device or send both to the first terminal device.

Optionally, the second terminal device may carry the CAPC information via an SL MAC CE, PC5-RRC signaling, or SCI.

Optionally, the second terminal device may send the CAPC information to the first terminal device when the first CAPC value of the packet to be sent is less than or equal to a preset threshold. Or the second terminal device may send the CAPC information to the first terminal device when the first CAPC value of the packet to be sent is greater than or equal to the preset threshold. Or the CAPC information may be sent to the first terminal device when other preset conditions are met, which is not limited in the present disclosure.

Optionally, the CAPC information is canceled in a case where the second terminal device determines that the CAPC information is sent to all first terminal devices.

The present embodiment may be combined with optional examples in other embodiments in the absence of contradiction, which is not limited in the present disclosure.

In the embodiment of the present disclosure, the second terminal device may send the CAPC information to the first terminal device in a case of meeting the CAPC trigger condition, so that waste of resources may be avoided. Moreover, if the first terminal device is a COT initiating terminal, the CAPC information is directly sent to the first terminal device, and the first CAPC value to be determined according to the CAPC information, COT wasting caused by sharing the COT with a terminal device, which cannot use the COT, may be avoided.

In order to facilitate understanding of the method for sharing the COT of the present disclosure, it is described below in conjunction with the following embodiment.

In an optional embodiment, the terminal device run in mode2 mode supports reporting the SL-BSR to the opposite end.

Optionally, the SL-BSR may be a periodic SL-BSR or a regular SL-BSR. Specifically, the periodic SL-BSR is triggered when the sl-periodicBSR-Timer times out. Specifically, the sl-retxBSR-Timer times out, and at least one logical channel belonging to the logical channel group (LCG) has the SL data; thus, the regular BSR is triggered. Specifically, an LCH among the LCG belonging to any target address has the SL data arriving at the MAC entity, where these SL data belong to the LCH with a higher priority class. A priority class of this LCH is higher than a priority class of all LCHs with data contained in any LCG belonging to the same target address. The regular BSR is triggered. Specifically, an LCH among the LCG belonging to any target address has the SL data arriving at the MAC entity, all LCHs contained in the LCG belonging to the same target address do not have the SL data available for sending, and thus the regular BSR is triggered.

Optionally, at least one of the periodic SL-BSR or the regular SL-BSR may be reported to all opposite ends that have unicast connections with the terminal device. Optionally, at least one of the periodic SL-BSR or the regular SL-BSR may be reported to all terminal devices in groups for a multicast service. Optionally, at least one of the periodic SL-BSR or the regular SL-BSR may be broadcast to other terminal devices via a broadcast service. Optionally, at least one of the periodic SL-BSR or the regular SL-BSR may be only reported to certain opposite ends. These opposite ends have unicast connections with this terminal device, and the terminal device has the SL data to be sent to these opposite end devices. That is, a buffer size corresponding to at least one LCG contained in the target address associated with this opposite end in the SL-BSR is not 0. The terminal device may implement the selection of certain opposite ends and send the SL-BSR to these opposite ends.

In an optional embodiment, the terminal device run in mode1 reports the SL-BSR to the opposite end device at the same time when it triggers the SL-BSR to be reported to the network device.

Optionally, the SL-BSR may be a periodic SL-BSR or a regular SL-BSR. The specific trigger condition refers to the embodiment of the first point above.

Optionally, the selection of the target terminal refers to the previous embodiment.

In an optional embodiment, the terminal device determines that the SL-BSR is sent to all target opposite ends. The terminal device cancels the SL-BSR.

In an optional embodiment, the terminal device run in mode1 or mode2 sends the CAPC information to the opposite end.

Optionally, the terminal device may periodically or regularly trigger the CAPC information to be reported to the opposite end. When the periodic SL-BSR or the regular SL-BSR is triggered, the CAPC information is simultaneously triggered to be reported to the opposite end. The terminal device determines the CAPC information through the triggered SL-BSR and reports the CAPC information to the opposite end. The CAPC information may be carried via an SL MAC CE, PC5-RRC signaling, or SCI.

Optionally, the selection of the target terminal refers to the previous embodiment.

In an optional embodiment, the terminal device determines that the CAPC information is sent to all target opposite ends. The terminal device cancels reporting of the CAPC information.

In an optional embodiment, the COT initiating terminal device only shares, according to the SL-BSR, the COT to a terminal device whose CAPC is less than or equal to the CAPC carried by the COT sharing information.

Optionally, the COT initiating terminal determines the CAPC of the packet of the opposite end according to the SL-BSR. If at least one of the following is satisfied: the opposite end is target receiving terminal of the COT initiating terminal or the CAPC of the SL data to be sent of the opposite end is less than the CAPC carried in the COT sharing information, the COT initiating terminal may share the COT with this opposite end.

Optionally, the SL data to be sent is merely for the COT initiating terminal. Optionally, the SL data to be sent may be sent to the COT initiating terminal or sent to other terminal devices.

The CAPC of the above SL data to be sent being less than the CAPC carried in the COT sharing information may mean that the CAPC value of the SL data to be sent is less than the CAPC value carried in the COT sharing information.

The present embodiment may be combined with optional examples in other embodiments in the absence of contradiction, which is not limited in the present disclosure.

FIG. 11 is a schematic structural diagram of a communication device provided by an embodiment of the present disclosure. The communication device 1100 shown in FIG. 11 may include a transceiving module 1101 and a processing module 1102. The transceiving module 1101 may include at least one of a sending module (not shown) or a receiving module(not shown). The sending module is configured to implement a sending function. The receiving module is configured to implement a receiving function. The transceiving module 1101 may implement at least one of a sending function or a receiving function.

It may be understood that the communication device 1100 may be a first terminal device, or a device in the first terminal device, or a device capable of being used in conjunction with the first terminal device.

The communication device 1100 is on a side of the first terminal device.

The transceiving module 1101 is configured to receive information related to a channel access priority class (CAPC) sent by a second terminal device.

Optionally, the first terminal device is a COT initiating terminal. The processing module 1102 is configured to: determine a first CAPC value of a packet to be sent in the second terminal device according to the information related to the CAPC; and share the COT with the second terminal device in a case where the first CAPC value is less than or equal to a second CAPC value carried in COT sharing information.

Optionally, the packet to be sent is only sent to the first terminal device, or the packet to be sent is sent to the first terminal device or sent to other terminal devices.

Optionally, the first terminal device is any one of: a terminal device that establishes a unicast connection with the second terminal device; a terminal device that belongs to a same multicast service as the second terminal device; a terminal device that receives a same broadcast service as the second terminal device; a terminal device that establishes the unicast connection with the second terminal device and receives the packet to be sent; or a terminal device that establishes the unicast connection with the second terminal device, wherein the second terminal device has the SL data to be sent to the terminal device.

Optionally, the information related to the CAPC is a sidelink buffer status report (SL-BSR) or CAPC information.

In the present disclosure, the first terminal device may receive the information related to the CAPC sent by the second terminal device. Thus, when initiating COT sharing, the first terminal device can determine, based on the information related to the CAPC, whether to share the COT with the second terminal device, so that COT wasting caused by sharing the COT with a terminal device, which cannot use the COT, can be avoided.

It may be understood that the communication device 1100 may be a second terminal device, or a device in the second terminal device, or a device capable of being used in conjunction with the second terminal device.

The communication device 1100 is on a side of the second terminal device.

The transceiving module 1101 is configured to send information related to a channel access priority class (CAPC) to the first terminal device.

Optionally, the transceiving module 1101 is configured to send the information related to the CAPC to the first terminal device in a case where a trigger condition for the information related to the CAPC is met.

Optionally, the transceiving module 1101 is configured to send an SL-BSR to the first terminal device in a case where the trigger condition for the information related to the CAPC is met. Optionally, the SL-BSR trigger condition includes at least one of: a sidelink BSR periodic timer timing out; a sidelink BSR retransmission timer timing out and at least one logical channel belonging to a logical channel group (LCG) having sidelink (SL) data; a first logical channel of an LCG belonging to any target address having the SL data arriving at a media access control (MAC) entity, and a priority class of the first logical channel is higher than a priority class of any LCH with the SL data contained in the LCG belonging to the same target address; or an LCH among the LCG belonging to any target address having the SL data arriving at the MAC entity, and all LCHs contained in the LCG belonging to the same target address not having the SL data available for sending.

Optionally, the processing module 1102 is further configured to cancel the information related to the CAPC in a case where it is determined that the information related to the CAPC is sent to all first terminal devices.

Optionally, an allocation manner of transmission resources of the second terminal device is network scheduling of the transmission resources or autonomous selection of the transmission resources.

Optionally, the information related to the CAPC is a SL-BSR or CAPC information.

Optionally, the information related to the CAPC is the SL-BSR. The transceiving module 1101 is configured to send the SL-BSR to the first terminal device after sending the SL-BSR to a network device.

Optionally, an allocation manner of transmission resources of the second terminal device is network scheduling of the transmission resources.

In the present disclosure, the second terminal device may send the information related to the CAPC to the first terminal device. Thus, when initiating COT sharing, the first terminal device can determine, based on the information related to the CAPC, whether to share the COT with the second terminal device, so that COT wasting caused by sharing the COT with a terminal device, which cannot use the COT, can be avoided.

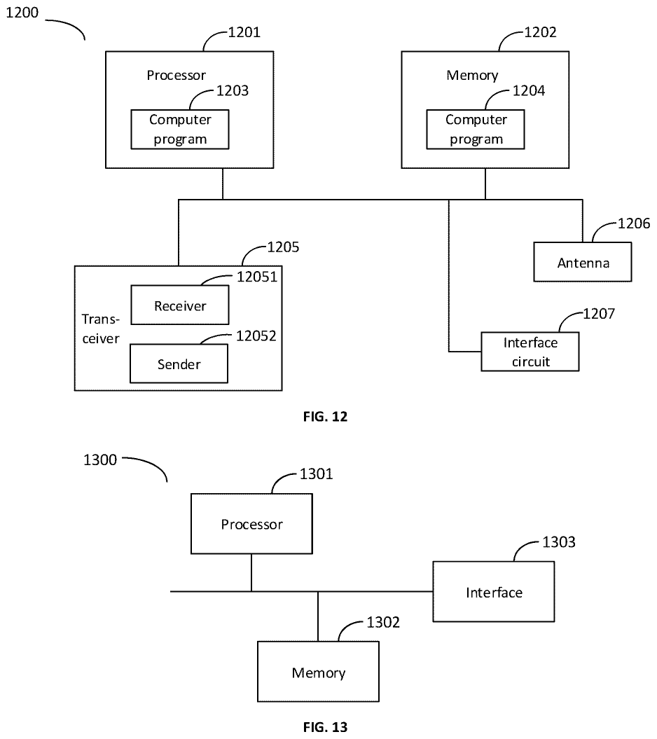

FIG. 12 is a schematic structural diagram of a communication device provided by another embodiment of the present disclosure. The communication device 1200 may be a network device, may further be a terminal device, may further be a chip, a chip system, or a processor, etc., that supports a network device to implement the above method, and may further be a chip, a chip system, or a processor, etc., that supports a terminal device to implement the above method. The device may be configured to implement the methods described in the method embodiments, the description in the method embodiments for details.

The communication device 1200 may include one or more processors 1201. The processor 1201 may be a general purpose processor or a specialized processor, etc. It may be, for example, a baseband processor or a central processing unit. The baseband processor may be configured to process a communication protocol and communication data, and the central processing unit may be configured to control a communication device (e.g., a base station, a baseband chip, a terminal device, a terminal device chip, a DU or a CU, etc.), executing a computer program, and processing data from the computer program.

Optionally, the communication device 1200 may include one or more memories 1202 on which a computer program 1204 may be stored, and the processor 1201 executes the computer program 1203 to enable the communication device 1200 to execute the methods described in the method embodiments above. Optionally, data may be stored in the memory 1202. The communication device 1200 and the memory 1202 may be arranged separately or may be integrated together.

Optionally, the communication device 1200 may include a transceiver 1205 and an antenna 1206. The transceiver 1205 may be referred to as a transceiving unit, a transceiver, or a transceiving circuit, etc., and is configured to implement a transceiving function. The transceiver 1205 may include a receiver 12051 and a sender 12052, the receiver 12051 may be referred to as a receiving machine or receiving circuit, etc., for implementing a receiving function, and the sender 12052 may be referred to as a sending machine or sending circuit, etc., for implementing a sending function.

Optionally, one or more interface circuits 1207 may be included in the communication device 1200. The interface circuit 1207 is configured to receive code instructions and transmit the same to the processor 1201. The processor 1201 runs the code instructions so as to enable the communication device 1200 to perform the method described in the above method embodiment.

The communication device 1200 is a first terminal device. The processor 1201 is configured to perform step 302, step 303, etc. in FIG. 3.

The communication device 1200 is a second terminal device. The transceiver 1205 is configured to perform step 401 in FIG. 4; step 501 in FIG. 5; step 601 in FIG. 6; step 701 in FIG. 7; step 801 in FIG. 8; step 901 in FIG. 9; step 1001 in FIG. 10, and the like.

In an implementation, the processor 1201 may include a transceiver for implementing receiving and sending functions. For example, the transceiver may be a transceiving circuit, an interface, or an interface circuit. The transceiving circuit, interface, or interface circuit is configured to implement the receiving and sending functions may be separate or integrated together. The transceiving circuit, interface or interface circuit may be used for reading and writing of a code/data, or the transceiving circuit, interface or interface circuit may be used for transmitting or passing of a signal.

In an implementation, the processor 1201 may store a computer program 1203, and the computer program 1203 run in the processor 1201 may enable the communication device 1200 to perform the methods described in the method embodiments. The computer program 1203 may be solidified in the processor 1201, in which case the processor 1201 may be implemented by hardware.

In an implementation, the communication device 1200 may include a circuit, and the circuit may implement the function of sending, receiving, or communicating in the foregoing method embodiment. The processor and transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, and the like. The processor and the transceiver may be fabricated using a variety of IC process technologies, such as a complementary metal oxide semiconductor (CMOS), a nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), and so on.

The communication device in the description of the other embodiments may be a network device or a terminal device, but the scope of the communication device described in the present disclosure is not limited to this, and the structure of the communication device may not be limited in FIG. 12. The communication device may be a separate device or may be part of a larger device. For example, the communication device may be: (1) a separate integrated circuit (IC), or chip, or, a chip system or subsystem; (2) a set having one or more ICs, optionally, the set of ICs may include a storage component for storing data and a computer program; (3) an ASIC, such as a modem; (4) a module that may be embedded within other devices; (5) a receiver, a terminal device, an intelligent terminal device, a cellular phone, a wireless device, a handset, a mobile unit, an in-vehicle device, a network device, a cloud device, an artificial intelligence device, etc. ; and (6) other, etc.

For the case where the communication device may be a chip or a chip system, a schematic structural diagram of a chip shown in FIG. 13 may be referred to. The chip shown in FIG. 13 includes a processor 1301 and an interface 1303. One or more processors 1301 may be arranged, and a plurality of interfaces 1303 may be arranged.

A case where the chip is configured to implement the functions of the first terminal device in the embodiments of the present disclosure is as follows.

The interface 1303 is configured to perform step 201 in FIG. 2; step 301 in FIG. 3, and the like A case where the chip is configured to implement the functions of the second terminal device in the embodiments of the present disclosure is as follows.

The interface 1303 is configured to perform step 401 in FIG. 4; step 501 in FIG. 5; step 601 in FIG. 6; step 701 in FIG. 7; step 801 in FIG. 8; step 901 in FIG. 9, and the like.

Optionally, the chip further includes a memory 1303. The memory 1303 is configured to store necessary computer programs and data.

Those skilled in the art may further appreciate that various illustrative logical blocks and steps set forth in the embodiments of the present disclosure may be implemented by electronic hardware, computer software, or a combination of the two. Whether such a function is implemented by hardware or software depends on a specific application and design requirements of an overall system. Those skilled in the art may, for each specific application, use various methods to implement the described function, but such implementation is not to be construed as being outside the scope of protection of the embodiments of the present disclosure.

As used herein, the term processor may refer to one processor that performs the defined functions or a plurality of processors that collectively perform defined functions, such that the execution of the individual defined functions may be divided amongst such processors.

The present disclosure further provides a non-transitory computer-readable storage medium in which an instruction is stored. When executed by a computer, the instruction implements the function of any one of the method embodiments.

The present disclosure further provides a computer program product. When executed by a computer, the computer program product implements the function of any one of the method embodiments.

In the embodiments, the function may be implemented in whole or in part by software, hardware, firmware, or any combination of them. When implemented by using software, the function may be implemented in whole or in part in the form of the computer program product. The computer program product includes one or more computer programs. When the computer program is loaded and executed on a computer, the process or function described according to the embodiments of the present disclosure is generated in whole or in part. The computer may be a general-purpose computer, a specialized computer, a computer network, or other programmable devices. The computer program may be stored in a computer readable storage medium or transmitted from one computer readable storage medium to another computer readable storage medium. For example, the computer program may be transmitted from one website, computer, server, or data center to another website, computer, server, or data center by wired (e.g., a coaxial cable, optical fiber, and digital subscriber line (DSL)) or wireless (e.g., infrared, wireless, microwave, etc.) means. The computer readable storage medium may be any available medium to which a computer can access or a data storage device such as a server, data center, etc., that contains one or more available medium integrations. The available medium may be a magnetic medium (e.g., a floppy disk, a hard disk, and a tape), an optical medium (e.g., a high-density digital video disc (DVD)), or a semiconductor medium (e.g., a solid state disk (SSD)), etc.

Those ordinarily skilled in the art may understand that first, second, and various other numerical numbers involved in the present disclosure are merely distinguished for descriptive convenience, are not used for limiting the scope of the embodiments the present disclosure, and also indicate the order of precedence.

“At least one” in the present disclosure may be described as one or more, and “plurality” may indicate two, three, four, or more, which is not limited in the present disclosure. In the embodiments of the present disclosure, for a technical feature, technical features in the technical feature are distinguished with “first,” “second,” “third,” “A,” “B,” “C,” “D,” etc. No sequential order or size order is indicated among the technical features described with “first,” “second,” “third,” “A,” “B,” “C,” and “D”.

Correspondences shown in tables in the present disclosure may be configured or may be predefined. Values of information in the tables are merely examples and may be configured to other values, which is not limited in the present disclosure. When a correspondence between information and each parameter is configured, it is not necessarily required that all correspondences illustrated in each table must be configured. For example, the correspondence illustrated in certain rows of the tables in the present disclosure may be unconfigured. As another example, appropriate transformation adjustments may be made based on the above table, e.g., splitting, merging, etc. Names of parameters shown in headings in the above tables may be other names understandable by the communication device, and values or representations of the parameters of which may be other values or representations understandable by the communication device. Each of the above tables may be implemented with other data structures. For example, an array, a queue, a container, a stack, a linear table, a pointer, a chained table, a tree, a graph, a structure, a class, a heap, a hash table, or a hash table, etc. may be used.

1. A method for sharing a channel occupancy time (COT), performed by a first terminal device, comprising:
receiving information related to a channel access priority class (CAPC) sent by a second terminal device.

2. The method according to claim 1, wherein the first terminal device is a COT initiating terminal, and the method further comprises:
determining a first CAPC value of a packet to be sent in the second terminal device, according to the information related to the CAPC; and
sharing the COT with the second terminal device, in a case where the first CAPC value is less than or equal to a second CAPC value carried in COT sharing information.

3. The method according to claim 2, wherein
the packet to be sent is only sent to the first terminal device; or
the packet to be sent is sent to the first terminal device or sent to other terminal devices.

4. The method according to claim 1, wherein the first terminal device is any one of:
a terminal device that establishes a unicast connection with the second terminal device;
a terminal device that belongs to a same multicast service as the second terminal device;
a terminal device that receives a same broadcast service as the second terminal device;
a terminal device that establishes the unicast connection with the second terminal device and receives a packet to be sent; or
a terminal device that establishes the unicast connection with the second terminal device, wherein the second terminal device has sidelink (SL) data to be sent to the terminal device.

5. The method according to claim 1, wherein the information related to the CAPC is a sidelink buffer status report (SL-BSR) or CAPC information.

6. A method for sharing a channel occupancy time (COT), performed by a second terminal device, comprising:
sending information related to a channel access priority class (CAPC) to a first terminal device.

7. The method according to claim 6, wherein sending the information related to the (CAPC) to the first terminal device comprises:
sending the information related to the CAPC to the first terminal device, in a case where a trigger condition for the information related to the CAPC is met.

8. The method according to claim 7, wherein the trigger condition for the information related to the CAPC comprises at least one of:
a sidelink buffer status report (SL-BSR) periodic timer timing out;
a SL-BSR retransmission timer timing out and at least one logical channel (LCH) belonging to a logical channel group (LCG) having sidelink (SL) data;
a first LCH of an LCG belonging to any target address having the SL data arriving at a media access control (MAC) entity, and a priority class of the first LCH being higher than a priority class of any LCH with the SL data contained in the LCG belonging to a same target address; or
an LCH among the LCG belonging to any target address having the SL data arriving at the MAC entity, and all LCHs contained in the LCG belonging to the same target address not having the SL data available for sending.

9. The method according to claim 6, further comprising:
canceling the information related to the CAPC, in a case where it is determined that the information related to the CAPC is sent to all first terminal devices.

10. The method according to claim 6, wherein the first terminal device is any one of:
a terminal device that establishes a unicast connection with the second terminal device;
a terminal device that belongs to a same multicast service as the second terminal device;
a terminal device that receives a same broadcast service as the second terminal device;
a terminal device that establishes the unicast connection with the second terminal device and receives a packet to be sent; or
a terminal device that establishes the unicast connection with the second terminal device, wherein the second terminal device has sidelink (SL) data to be sent to the terminal device.

11. The method according to claim 6, wherein an allocation manner of transmission resources of the second terminal device is network scheduling of the transmission resources or autonomous selection of the transmission resources.

12. The method according to claim 6, wherein the information related to the CAPC is a sidelink buffer status report (SL-BSR) or CAPC information.

13. The method according to claim 6, wherein the information related to the CAPC is a sidelink buffer status report (SL-BSR), and sending the information related to the (CAPC) to the first terminal device comprises:
sending the SL-BSR to the first terminal device after sending the SL-BSR to a network device.

14-15. (canceled)

16. A communication device, comprising:
one or more processors; and
a memory that stores a computer program,
wherein the one or more processors are collectively configured to executes the computer program stored in the memory to cause the communication device to:
receive information related to a channel access priority class (CAPC) sent by a second terminal device.

17. A non-transitory computer-readable storage medium storing instructions, wherein the instructions, when executed by a processor, cause the processor to implement the method according to claim 1.

18. A communication device, comprising:
one or more processors; and
a memory that stores a computer program,
wherein the one or more processors are collectively configured to execute the computer program stored in the memory to cause the communication device to perform the method according to claim 6.

19. A non-transitory computer-readable storage medium storing instructions, wherein the instructions, when executed by a processor, cause the processor to implement the method according to claim 6.

20. The communication device according to claim 16, wherein a first terminal device is a channel occupancy time (COT) initiating terminal, and the one or more processors are collectively configured to execute the computer program to cause the communication device to further perform:
determining a first CAPC value of a packet to be sent in the second terminal device, according to the information related to the CAPC; and
sharing the COT with the second terminal device, in a case where the first CAPC value is less than or equal to a second CAPC value carried in COT sharing information.

21. The communication device according to claim 20, wherein
the packet to be sent is only sent to the first terminal device; or
the packet to be sent is sent to the first terminal device or sent to other terminal devices.

22. The communication device according to claim 20, wherein the first terminal device is any one of:
a terminal device that establishes a unicast connection with the second terminal device;
a terminal device that belongs to a same multicast service as the second terminal device;
a terminal device that receives a same broadcast service as the second terminal device;
a terminal device that establishes the unicast connection with the second terminal device and receives a packet to be sent; or
a terminal device that establishes the unicast connection with the second terminal device, wherein the second terminal device has sidelink (SL) data to be sent to the terminal device.
